(19) United States
(12) Patent Application Publication
(10) Pub. No.: US 2013/0154464 A1
(43) Pub. Date: Jun. 20, 2013

(54) CAM PLATE FOR A DOOR HINGE ASSEMBLY OF A DOMESTIC REFRIGERATOR

(71) Applicants: MICHAEL A. FIORI, Evansville, IN (US); DOUGLAS P. SPRAGUE, Newburgh, IN (US); PATRICIA ANKIR WILSON, Evansville, IN (US)

(72) Inventors: MICHAEL A. FIORI, Evansville, IN (US); DOUGLAS P. SPRAGUE, Newburgh, IN (US); PATRICIA ANKIR WILSON, Evansville, IN (US)

(73) Assignee: WHIRLPOOL CORPORATION, BENTON HARBOR, MI (US)

(21) Appl. No.: 13/326,963

(22) Filed: Dec. 15, 2011

(51) Int. Cl. F25D 23/02; E05F 1/12

(52) U.S. Cl. 312/405; 16/303

(57) ABSTRACT

A cam plate for door hinge assembly of a domestic refrigerator includes a plate body having a cam surface that is configured to engage a corresponding cam surface positioned at an end of a refrigerator door. The plate body has a plug that extends from the plate body and a resilient tongue including a catch extending outwardly therefrom.

### TECHNICAL FIELD

The present disclosure relates generally to a door hinge assembly of a domestic refrigerator and more particularly to a cam plate for a door hinge assembly of a domestic refrigerator.

### BACKGROUND

A domestic refrigerator is a device used to store food items in a home at preset temperatures. A domestic refrigerator typically includes one or more temperature-controlled compartments into which food items may be placed to preserve the food items for later consumption. A domestic refrigerator also typically includes a door that permits user access to the temperature-controlled compartment defined in the refrigerator cabinet. The door may be mounted to the cabinet via a hinge assembly.

### SUMMARY

According to one aspect of the disclosure, a domestic refrigerator includes a cabinet having a temperature-controlled compartment defined therein, a door positioned at a front of the cabinet, a first cam plate positioned at a first end of the door that includes a first cam surface, and a hinge bracket coupled to the cabinet. The hinge bracket includes a mounting plate and an inner wall that defines a slot through the mounting plate. The refrigerator also includes a second cam plate positioned between the mounting plate and the first cam plate. The second cam plate includes a plate body having a second cam surface engaged with the first cam surface of the first cam plate, and a plug extending from the plate body through the slot defined in the mounting plate. The plug includes a resilient tongue having a catch formed thereon to engage a surface of the mounting plate to prevent removal of the second cam plate from the hinge bracket.

In some embodiments, the domestic refrigerator may include a hinge pin coupled to the hinge bracket and extending through a bore defined in the plate body. Additionally, in some embodiments, the hinge pin may be threadingly coupled to the hinge bracket. When the hinge pin is rotated in a first direction, the door, the first cam plate, and the second cam plate may be moved upward relative to the cabinet. When the hinge pin is rotated in a second direction, the door, the first cam plate, and the second cam plate may be moved downward relative to the cabinet.

In some embodiments, when the hinge pin is rotated in the first direction, the plug may be configured to slide upward along the inner wall of the hinge bracket. In some embodiments, the plug may define a first longitudinal axis and the hinge pin may define a second longitudinal axis offset from and extending parallel to the first longitudinal axis.

In some embodiments, the plug may include an outer surface facing the inner wall of the hinge bracket and a rib extending from the outer surface. The rib may engage the inner wall of the hinge bracket. In some embodiments, the outer surface of the plug may be convex. Additionally, in some embodiments, the slot defined in the mounting plate may be oblong. In some embodiments, the rib of the plug may engage a substantially planar inner wall section of the inner wall, and the resilient tongue may have an outer surface facing a concave inner wall section of the inner wall.

In some embodiments, the resilient tongue may be a first resilient tongue, and the plug may include a second resilient tongue extending parallel to the first resilient tongue. The plug may include a body positioned between the first resilient tongue and the second resilient tongue.

According to another aspect, a refrigerator door hinge assembly is disclosed. The refrigerator door hinge assembly includes a hinge bracket including a mounting plate and an inner wall that defines a slot through the mounting plate, and a cam plate coupled to the hinge bracket. The cam plate includes a plate body having a cam surface configured to engage a corresponding cam surface positioned at a lower end of a refrigerator door, and a plug extending from the plate body through the slot defined in the mounting plate. The refrigerator door hinge assembly also includes a hinge pin moveably coupled to the hinge bracket, and the hinge pin includes a shaft that extends through an opening defined in the plate body. The plug of the cam plate includes a pair of resilient tongues and a body positioned between the resilient tongues. Each resilient tongue has a catch formed thereon to engage a bottom surface of the mounting plate. The body engages the inner wall of the hinge bracket. In some embodiments the engagement of the cam plate to the bracket may be permanently affixed. In some embodiments the engagement of the cam plate to the bracket may be removable with a tool. In some embodiments the engagement of the cam plate to the bracket may be friction mounted.

In some embodiments, the inner wall of the hinge bracket may include a pair of substantially planar wall sections and a pair of concave wall sections connecting the pair of substantially planar wall sections. In some embodiments, the body of the plug may include a first beam including a first convex outer surface facing a first wall section of the pair of substantially planar wall sections, a second beam including a second convex outer surface facing a second wall section of the pair of substantially planar wall sections, and a third beam connecting the first beam to the second beam. Each of the resilient tongues may have an outer surface that faces one of the pair of concave wall sections.

Additionally, in some embodiments, the plug may include a first rib extending from the first convex outer surface. The first rib may be engaged with the first wall section of the hinge bracket. The plug may also include a second rib extending from the second convex outer surface. The second rib may be engaged with the second wall section of the hinge bracket.

According to another aspect, a door cam plate for a domestic refrigerator is disclosed. The door cam plate includes a plate body including an upper surface, a lower surface positioned opposite the upper surface, and a circular bore extending through the upper surface and the lower surface. The door cam plate also includes a pair of curved walls extending upwardly from the upper surface adjacent the circular bore, and a plug extending downwardly from the lower surface of the plate body. Each curved wall includes a cam surface configured to engage a corresponding cam surface positioned at a lower end of a refrigerator door. The plug includes a first resilient tongue having a first catch extending outwardly from a lower end thereof, a second resilient tongue having a second catch extending outwardly from a lower end thereof, and a body positioned between the first resilient tongue and the second resilient tongue.

In some embodiments, the body may include a first beam including a first convex outer surface, a second beam including a second convex outer surface, and a third beam connecting the first beam to the second beam. Additionally, in some embodiments, the plug may include a first rib extending outwardly from the first convex outer surface and a second rib extending outwardly from the second convex outer surface. In some embodiments, the third beam may define an axis, and the first rib and the second rib may be positioned on the axis.

In some embodiments, the first catch may extend in a first direction orthogonal to the axis, and the second catch may extend in a second direction opposite the first direction and orthogonal to the axis. Additionally, in some embodiments, the plate body may include a convex outer surface connecting the upper surface and the lower surface.

### BRIEF DESCRIPTION OF THE DRAWINGS

The detailed description particularly refers to the following figures, in which:

FIG. 1 is a front elevation view of a domestic refrigerator including one embodiment of a hinge assembly;

FIG. 2 is an exploded perspective view a door and the hinge assembly of FIG. 1;

FIG. 3 is a bottom perspective view of a cam plate of the hinge assembly of FIG. 1;

FIG. 4 is a fragmentary bottom plan view of the cam plate and a hinge bracket of the hinge assembly of FIG. 1;

FIG. 5 is a cross-sectional side elevation view of the hinge assembly of FIG. 1 showing the door and the cam plate in a lowered position;

FIG. 6 is a cross-sectional side elevation view similar to FIG. 5 showing the door and the cam plate in a raised position; and

FIG. 7 is a fragmentary top plan view of the cam plate and the hinge bracket of the hinge assembly of FIG. 1.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

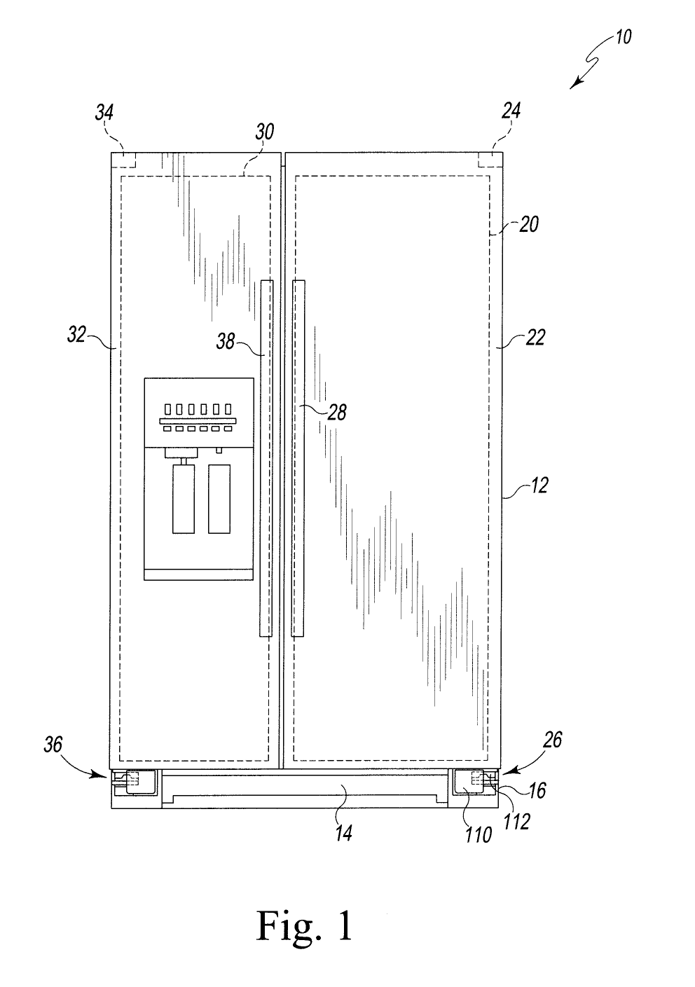

Referring to FIG. 1, a home appliance is shown as a domestic refrigerator appliance 10 (hereinafter refrigerator 10). The refrigerator 10 includes a cabinet 12 and a base grille 14 secured to the lower front 16 of the cabinet 12. The refrigerator cabinet 12 defines a refrigerated compartment 20 into which a user may place and store food items such as milk, cheese, produce, etcetera. The refrigerated compartment 20 is operable to maintain stored food items at a predefined temperature. The refrigerator 10 may include one or more shelves positioned within the refrigerated compartment 20 that provide storage locations for the food items.

A door 22 is hinged to the front of the refrigerator cabinet 12 via an upper hinge assembly 24 and a lower hinge assembly 26, as described in greater detail below. The door 22 permits user access to the refrigerated compartment 20 such that food items may be placed in and retrieved from the refrigerator 10. When the door 22 is closed as shown in FIG. 1, user access to the refrigerated compartment 20 is prevented. A handle 28 is located on a front panel of the door 22, and the user may use the handle to pull the door 22 open. When the door 22 is open, user access to the refrigerated compartment 20 is permitted.

As shown in FIG. 1, the refrigerator cabinet 12 also defines a freezer compartment 30, which is independently operable to maintain food items stored therein at a certain temperature. A door 32 is hinged to the front of the refrigerator cabinet 12 via an upper hinge assembly 34 and a lower hinge assembly 36. The door 32 permits user access to the freezer compartment 30 such that food items may be placed in and retrieved from the refrigerator 10. When the door 22 is closed as shown in FIG. 1, user access to the freezer compartment 30 is prevented. A handle 38 is located on the door 32, and the user may use the handle 38 to pull the door 32 open. When the door 32 is open, user access to the freezer compartment 30 is permitted. The freezer compartment 30 and the refrigerated compartment 20 are shown side-by-side. It should be appreciated that in other embodiments the freezer compartment may be positioned below or above with the refrigerated compartment 20, either as a free standing refrigerator or a built-in refrigerator. It will be further appreciated that in other embodiments the refrigerator 10 may not have a freezer compartment.

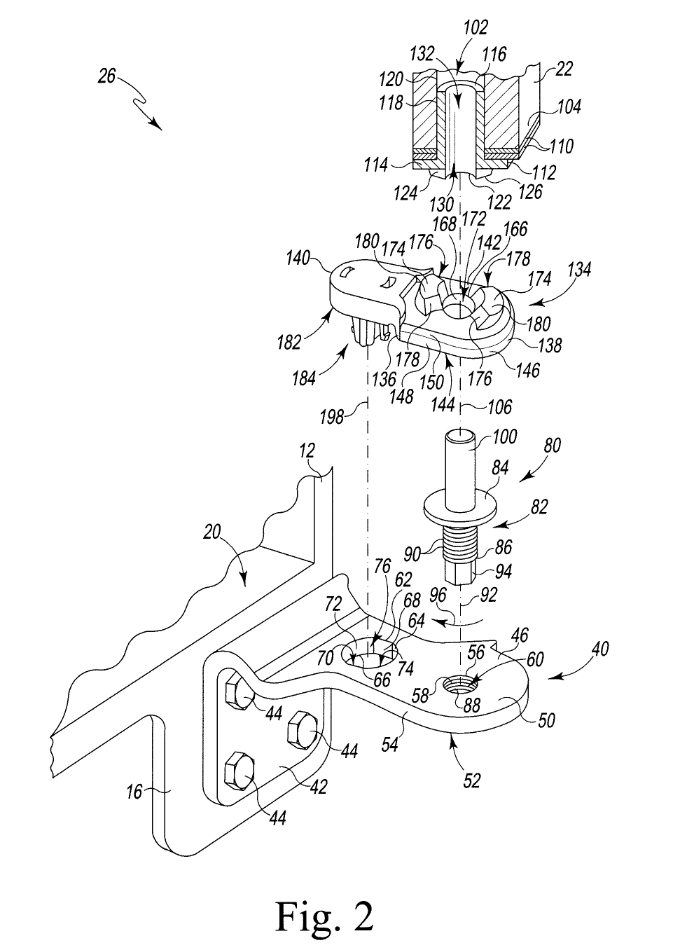

Referring now to FIG. 2, the lower hinge assembly 26 includes a hinge bracket 40 that is secured to the lower front 16 of the cabinet 12. In this embodiment the hinge bracket 40 is formed from a metallic material, such as, for example, steel, and is sized to support the weight of the door 22. The hinge bracket 40 includes a vertical flange 42 attached to the lower front 16 via a plurality of bolts 44, which extend through holes (not shown) formed in the flange 42 and engage the cabinet 12. The hinge bracket 40 also includes a horizontally-extending mounting plate 46.

The mounting plate 46 extends outwardly from the flange 42 and the cabinet 12 when the hinge bracket 40 is secured to the cabinet 12. The mounting plate 46 has an upper surface 50, a lower surface 52 positioned opposite the upper surface 50, and an outer side wall 54 extending between the surfaces 50, 52. An opening 56 is defined in the upper surface 50 of the mounting plate 46, and an inner wall 58 extends downwardly from the opening 56 to define a bore 60 through the mounting plate 46. As shown in FIG. 2, the opening 56 is circular, and the bore 60 is substantially cylindrical. It should be appreciated that in other embodiments the opening may be oblong, square, or other geometric shapes.

Another opening 62 is defined in the upper surface 50 of the mounting plate 46 and is positioned between the bore 60 and the flange 42 of the hinge bracket 40. As shown in FIG. 2, the opening 62 is oblong, but it should be appreciated that in other embodiments the opening may be circular, square, or other geometric shape. It should also be appreciated that the shape of opening 62 may be selected to assist in the proper alignment or retention of the cam plate 134 (discussed later) to hinge bracket 34. In the present embodiment the opening 62 is oblong to assist in both alignment and retention of cam plate 134 due to the dimensions and catches of plug 184 (discussed later). An inner wall 64 extends downwardly from the opening 62 to an opening 66 defined in the lower surface 52. The inner wall 64 includes a pair of substantially planar wall sections 68, 70 and a pair of concave wall sections 72, 74 that cooperate to define a slot 76 through the mounting plate 46. It should be appreciated that in other embodiments the slot may be cylindrical or may take other geometric forms.

The hinge assembly 26 of the refrigerator 10 also includes a hinge pin 80 configured to be coupled to the hinge bracket 40. The hinge pin 80 includes a base 82 and a circular flange 84 that extends outwardly from the base 82. The base 82 has an externally-threaded body 86 that extends downwardly from the circular flange 84. As shown in FIG. 2, the externally-threaded body 86 is sized to be received in the bore 60 of the hinge bracket 40.

As described above, the inner wall 58 of the hinge bracket 40 defines the bore 60 through the mounting plate 46. The inner wall 58 has a number of internal threads 88, which correspond to the external threads 90 of the hinge pin 80. When the base 82 of the hinge pin 80 is received in the bore 60 of the hinge bracket 40, the externally-threaded body 86 is engaged with the internally-threaded inner wall 58. The threaded engagement between the body 86 and the inner wall 58 permits the hinge pin 80 to be rotated about a vertically-extending longitudinal axis 92 while coupled to the hinge bracket 40.

As shown in FIG. 2, the lower end 94 of the base 82 of the hinge pin 80 is keyed and sized to receive a socket or other tool that may be used to rotate the hinge pin 80 about the axis 92. When the hinge pin 80 is rotated in the direction indicated by arrow 96, the circular flange 84 is moved downward, toward the upper surface 50 of the mounting plate 46. When the hinge pin 80 is rotated in the opposite direction, the circular flange 84 is moved upward, away from the upper surface 50 of the mounting plate 46. In that way, the vertical position of the door 22 relative to the cabinet 12 and the door 32 may be adjusted, as described in greater detail below.

The hinge pin 80 of the hinge assembly 26 includes a cylindrical shaft 100 that extends upwardly from the circular flange 84. The shaft 100 is sized to be received in an opening 102 defined in a lower end 104 of the door 22. The shaft 100 defines a rotational axis 106 about which the door 22 may pivot between the open position and the closed position. In the illustrative embodiment, the rotational axis 106 is coaxial with the longitudinal axis 92, but it should be appreciated that in other embodiments the axes 106, 92 may be offset from one another.

In the illustrative embodiment, the hinge pin 80 is formed as a single monolithic component from a metallic material, such as, for example, steel. In other embodiments, the base 82, the circular flange 84, and the shaft 100 may be formed as separate components that are assembled. It should be appreciated that the configuration of one or more of those components of the hinge pin 80 may be modified in other embodiments. It should further be appreciated that in other embodiments one or more of the components may be made from a polymeric material, such as, for example, a rigid plastic.

As shown in FIG. 2, the refrigerator 10 includes a cover plate and bracket 110 and a cam support 112 that is secured to the lower end 104 of the door 22. In the illustrative embodiment, the cam support 112 is formed from a polymeric material, such as, for example, polymide or, more specifically, nylon, but, in other embodiments, the support 112 may be formed from a metallic material. The cam support 112 includes an upper cam plate 114 and a hollow rod 116 extending upwardly from the cam plate 114. The hollow rod 116 is received in the opening 102 defined in the lower end 104 of the door 22. The hollow rod 116 has an outer surface 118 that engages an inner surface 120 of the door 22. The engagement between the surfaces 118, 120 prevents relative axial movement between the cam support 112 and the door 22 such that the support 112 pivots with the door 22 about the axis 106 as the door 22 moves between the open position and the closed position.

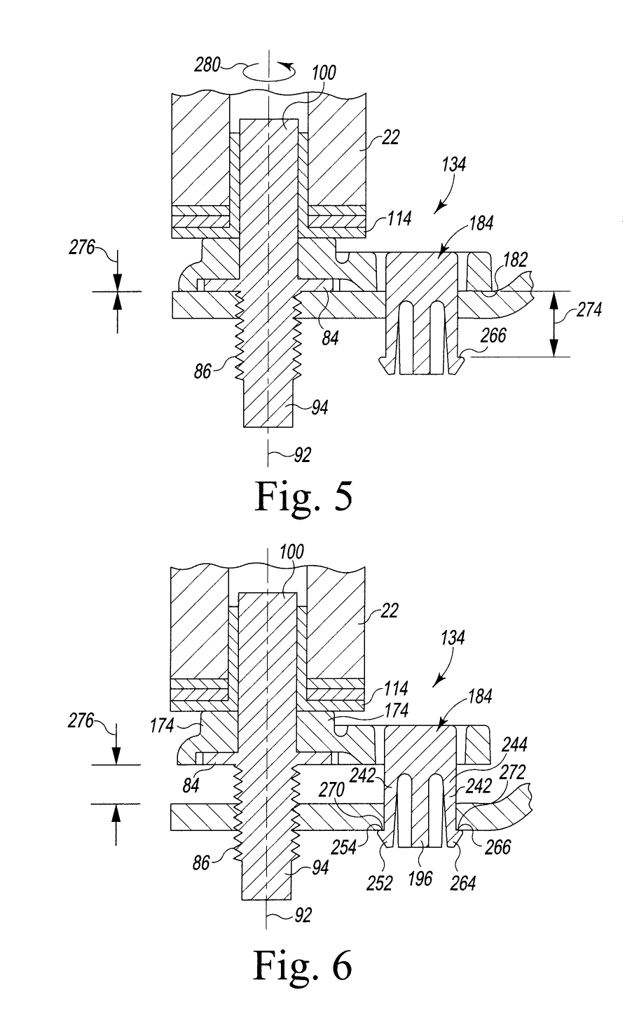

The cam plate 114 of the support 112 has a pair of curved walls 122 extending downwardly therefrom. Each wall 122 of the cam plate 114 includes a pair of angled cam surfaces 124, 126 and a substantially planar bottom surface 128 connecting the cam surfaces 124, 126. The walls 122 are arranged around the outer circumference of an opening 130 defined in the cam plate 114. As shown in FIG. 2, a cylindrical passageway 132 extends upwardly from the opening 130 through the cam plate 114 and the hollow rod 116 of the support 112. When door 22 is lowered onto the hinge pin 80, the shaft 100 of the hinge pin 80 is received in the cylindrical passageway 132 (see FIGS. 5 and 6) of the support 112.

As shown in FIG. 2, the hinge assembly 26 includes a lower cam plate 134 configured to be coupled to the hinge bracket 40. In the illustrative embodiment, the lower cam plate 134, like the cam support 112, is formed from a polymeric material, such as, for example, polyphthalamide (PPA), but, in other embodiments, the lower cam plate 134 may be formed from a metallic material. When the hinge assembly 26 and the door 22 are assembled, the upper cam plate 114 engages the lower cam plate 134 of the cam support 112, as described in greater detail below. The lower cam plate 134 has a main body 136 that is positioned between the upper cam plate 114 and the mounting plate 46 of the hinge bracket 40. The main body 136 includes a platform 138 and a support arm 140 that extends outwardly from the platform 138.

The platform 138 of the lower cam plate 134 has upper surface 142, a bottom surface 144 positioned opposite the upper surface 142, and an outer side wall 146 that connects the surfaces 142, 144. The outer side wall 146 of the platform 138 has a substantially planar surface 148 that extends upwardly from the bottom surface 144. The outer side wall 146 also has a convex surface 150 that bows outwardly from the upper surface 142 to meet the substantially planar surface 148.

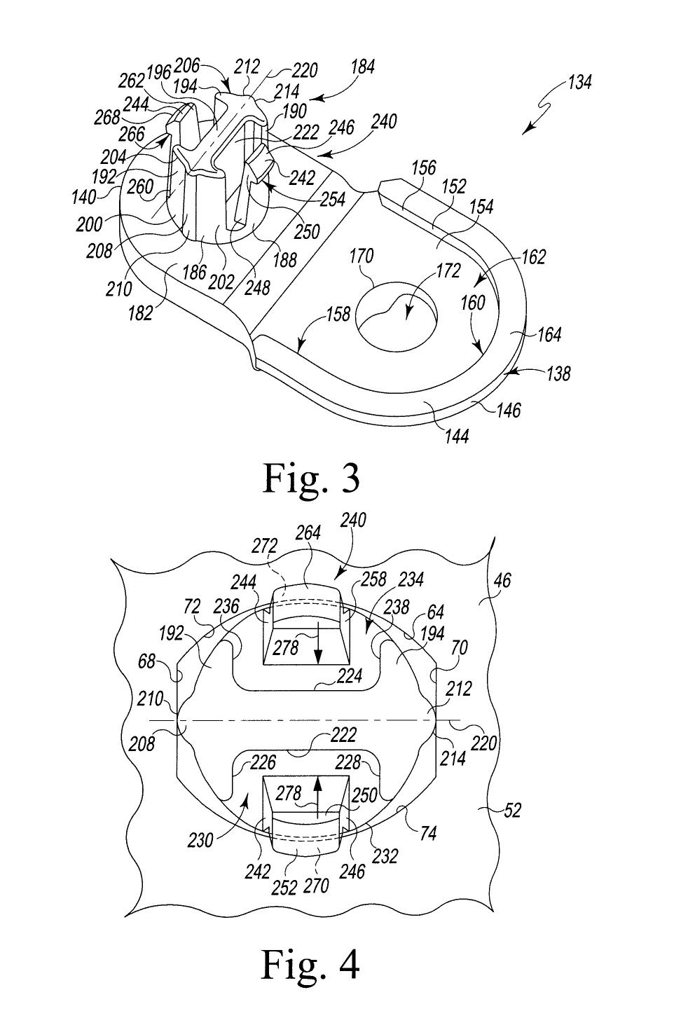

As shown in FIG. 3, the platform 138 of the lower cam plate 134 includes an inner wall 152 that extends upwardly from the bottom surface 144 to an inner surface 154. The inner wall 152 includes a pair of substantially planar side surfaces 156, 158 and a curved side surface 160 extending between the surfaces 156, 158. The surfaces 154, 156, 158, 160 cooperate to define a cavity 162 in the platform 138 that receives the circular flange 84 of the hinge pin 80. The platform 138 further includes an outer rim 164 defined between the inner wall 152 and the outer side wall 146.

Returning to FIG. 2, the upper surface 142 of the platform 138 has an opening 166 defined therein. A cylindrical inner wall 168 extends downwardly from the opening 166 to an opening 170 in the inner surface 154, thereby defining a bore 172 through the platform 138 of the cam plate 134. When the hinge assembly 26 is assembled, the cylindrical shaft 100 of the hinge pin 80 extends through the bore 172 and into the passageway 132 of the cam support 112.

The platform 138 of the lower cam plate 134 has a pair of curved walls 174 extending upwardly from the upper surface 142. As shown in FIG. 2, the walls 174 are arranged around the outer circumference of the opening 166 defined in the cam plate 134. Each wall 174 of the cam plate 134 includes a pair of angled cam surfaces 176, 178 that extend between the upper surface 142 of the platform 138 and a substantially planar top surface 180 of the curved wall 174. The top surface 180 of each curved wall 174 connects the cam surface 176 to the other cam surface 178 of the curved wall 174. The cam surfaces 176, 178 of the lower cam plate 134 are configured to engage the cam surfaces 124, 126 of the upper cam plate 114 when the door 22 and the hinge assembly 26 are assembled.

As described above, the main body 136 of the lower cam plate 134 includes a support arm 140 extends from the platform 138. The support arm 140 includes a substantially planar bottom surface 182 that is co-planar with the bottom surface 144 of the platform 138. The surfaces 144, 182 of the lower cam plate 134 are configured to contact the upper surface 50 of the hinge bracket 40 when the hinge assembly 26 is assembled.

Referring now to FIGS. 3 and 4, the lower cam plate 134 includes a locking plug 184 that extends downwardly from the bottom surface 182. When the hinge assembly 26 is assembled, the plug 184 extends through the slot 76 of the hinge bracket 40. As described in greater detail below, the locking plug 184 is configured to prevent the lower cam plate 134 from pivoting with the door 22 when the door 22 is opened and closed. The plug 184 of the lower cam plate 134 includes a base 186 that is attached to the bottom surface 182 of the support arm 140, and the base 186 has an outer perimeter surface 188.

The plug 184 of the lower cam plate 134 also includes a lower body 190 that is attached to the base 186. In the illustrative embodiment, the lower body 190 of the locking plug 184 includes a pair of outer beams 192, 194 extending downwardly from the base 186. A center beam 196, which also extends downwardly from the base 186, connects the outer beam 192 to the outer beam 194. As shown in FIG. 2, the plug 184 has a longitudinal axis 198 that extends vertically through the center beam 196. The longitudinal axis 198 of the plug 184 is offset from, and extends parallel to, the longitudinal axis 92 of the hinge pin 80.

The outer beam 192 of the lower body 190 has an outer surface 200 that extends from an upper end 202 to a lower end 204. In the illustrative embodiment, the outer surface 200 is convex. It should be appreciated that in other embodiments the surface 200 may be flat or substantially planar. The other outer beam 194 also has an outer surface 206 that extends from the upper end 202 to the lower end 204 of the lower body 190. In the illustrative embodiment, the outer surface 206 is convex. It should be appreciated that in other embodiments the surface 206 may be flat or substantially planar.

The plug 184 also includes a longitudinal rib 208 extending outwardly from the surface 200 of the outer beam 192 and the surface 188 of the base 186. The rib 208 extends between the bottom surface 182 of the support arm 140 and the lower end 204 of the lower body 190. In the illustrative embodiment, the rib 208 has a semi-circular cross-section and includes a convex outer surface 210. It should be appreciated that in other embodiments the rib 208 may have a square, triangular, rectangular, or other cross-section.

As shown in FIGS. 3 and 4, the plug 184 of the lower cam plate 134 includes another longitudinal rib 212, which extends outwardly from the surface 206 of the outer beam 194 and the surface 188 of the base 186. The rib 212, like the rib 208, extends between the bottom surface 182 of the support arm 140 and the lower end 204 of the lower body 190. In the illustrative embodiment, the rib 212 has a semi-circular cross-section and includes a convex outer surface 214. It should be appreciated that in other embodiments the rib 212 may have a square, triangular, rectangular, or other cross-section. As shown in FIG. 3, the ribs 208, 212 of the plug 184 are positioned on opposite sides of the plug 184 along an axis 220 defined by the center beam 196.

As shown in FIG. 4, the ribs 208, 212 of the plug 184 engage the inner wall 64 of the mounting plate 46 of the hinge bracket 40. In the illustrative embodiment, the rib 208 of the plug 184 engages the planar wall section 68 of the inner wall 64, and the rib 212 of the plug 184 engages the opposite planar wall section 70 of the inner wall 64. It should be appreciated that in embodiments in which the ribs are omitted, the outer surface or surfaces of the lower body of the plug may directly engage the inner wall 64 of the mounting plate 46.

The center beam 196 of the lower body 190 includes a side surface 222 and another side surface 224 that is positioned opposite the side surface 222. The outer beam 192 has an inner surface 226 extending outwardly from the side surface 222 of the center beam 196, and the outer beam 194 has an inner surface 228 that extends outwardly from the side surface 222. The surfaces 222, 226, 228 define a channel 230 in one side 232 of the plug 184. The channel 230 extends from the upper end 202 to the lower end 204 of the lower body 190.

Similarly, another channel 234 is defined in the plug 184 in an opposite side 234 thereof. The outer beam 192 has an inner surface 236 that extends outwardly from the side surface 224 of the center beam 196, and the outer beam 194 has an inner surface 238 that extends outwardly from the side surface 224. The surface 224, 236, 238 define the channel 234, which extends from the upper end 202 to the lower end 204 of the lower body 190.

The lower cam plate 134 of the hinge assembly 26 also includes a retention mechanism 240 to prevent inadvertent removal of the lower cam plate 134 from the hinge bracket 40. As shown in FIGS. 3 and 4, the retention mechanism 240 includes a pair of resilient tongues 242, 244 that extend downwardly from the base 186 of the plug 184. It should be appreciated that in other embodiments the retention mechanism may include only a single resilient tongue or additional tongues to prevent the inadvertent removal of the cam plate from the hinge bracket. The resilient tongue 242 includes an arm 246 having an upper end 248 attached to the base 186 and a lower end 250 positioned adjacent to the lower end 204 of the lower body 190. The resilient tongue 242 also includes a catch 252 that extends outwardly from the lower end 250 of the arm 246. The catch 252 has a planar upper surface 254 and a tapered lower surface 256 extending downwardly from the upper surface 254.

The resilient tongue 244 of the retention mechanism 240 includes an arm 258 having an upper end 260 attached to the base 186 and a lower end 262 positioned adjacent to the lower end 204 of the lower body 190. As shown in FIGS. 3 and 4, the lower body 190 of the plug 184 is positioned between the arms 246, 258 of the tongues 242, 244. The resilient tongue 244 also includes a catch 264 that extends outwardly from the lower end 262 of the arm 246. The catch 264 has a planar upper surface 266 and a tapered lower surface 268 extending downwardly from the upper surface 266.

As shown in FIG. 4, the catches 252, 264 of the retention mechanism 240 are configured to engage the lower surface 52 of the mounting plate 46 of the hinge bracket 40. In the illustrative embodiment, the arm 246 of the resilient tongue 242 faces the concave wall section 74 of the inner wall 64 of the mounting plate 46, and the catch 252 is configured to engage a section 270 of the lower surface 52 adjacent to the wall section 74. The arm 258 of the resilient tongue 244 faces the concave wall section 72 of the inner wall 64 of the mounting plate 46, and the catch 264 is configured to engage a section 272 of the lower surface 52 adjacent to the wall section 72.

The catches 252, 264 of the tongues 242, 244, respectively, extend orthogonally to the axis 220 defined by the center beam 196 of the plug 184 and in opposite directions. As shown in FIG. 5, a distance 274 is defined between the upper surfaces 254, 266 of the catches 252, 264 and the bottom surface 182 of the support arm 140 of the cam plate 134. In the illustrative embodiment, the distance 274 is approximately 12.2 millimeters. It should be appreciated that in other embodiments the distance may be increased or decreased, depending on, for example, the thickness of mounting plate 46 of the hinge bracket 40.

To assemble the hinge assembly 26, the hinge pin 80 is aligned with the opening 56 defined in the mounting plate 46 of the hinge bracket 40. The base 82 of the hinge pin 80 is advanced into the bore 60 of the mounting plate 46, and the hinge pin 80 is rotated about the axis 92 to engage the external threads 90 of the base 82 with the internal threads 88 of the mounting plate 46. As shown in FIGS. 5 and 6, a vertical distance 276, which corresponds to the position of the door 22 relative to the cabinet 12 and the door 32, is defined between the circular flange 84 of the hinge pin 80 and the upper surface 50 of the mounting plate 46. The user may continue to advance the hinge pin 80 deeper into the bore 60 to adjust the distance 276.

To attach the lower cam plate 134, the plug 184 of the lower cam plate 134 is aligned with the slot 76 defined in the mounting plate 46 of the hinge bracket 40, as shown in FIG. 2. Additionally, the bore 172 of the cam plate 134 is aligned with the cylindrical shaft 100 of the hinge pin 80. The lower cam plate 134 is then advanced downward so that the shaft 100 is received in the bore 172 and the lower surfaces 256, 268 of the catches 252, 264 are advanced into contact with the concave wall sections 72, 74, respectively, of the mounting plate 46. By pressing downward on the lower cam plate 134, the lower surfaces 256, 268 of the catches 252, 264 are advanced along the concave wall sections 72, 74, thereby causing the resilient tongues 242, 244 to bend inward, indicated in FIG. 4 by arrows 278. When the catches 252, 264 pass through the slot, the resilient tongues 242, 244 snap back to their original forms, as shown in FIG. 5. The cam plate 134 may be advanced downward until the circular flange 84 of the hinge pin 80 engages the inner surface 154 of the cam plate 134 in the cavity 162.

If the cam plate 134 is moved upward, the upper surface 254 of the catch 252 may be advanced into contact with the section 270 of the lower surface 52 of the mounting plate 46. Similarly, the upper surface 266 of the other catch 264 may be advanced into contact with the surface section 272. The engagement between the catches 252, 264 and the mounting plate 46 retains the plug 184 in the slot 76, thereby preventing the inadvertent removal of the lower cam plate 134 from the hinge bracket 40.

When the hinge pin 80 and the cam plate 134 are attached to the hinge bracket 40, the door 22 may be lowered onto the hinge pin 80. The shaft 100 of the hinge pin 80 is aligned with the opening 130 of the upper cam plate 114, and the door 22 is lowered such that the shaft 100 is received in the cylindrical passageway 132. As shown in FIGS. 5 and 6, the upper cam plate 114 engages the lower cam plate 134 when the door 22 is properly positioned on the hinge pin 80.

The user may then adjust the vertical height of the door 22 relative to the cabinet 12 and the door 32. To do so, the user may attach a socket or other tool to the lower end 94 of the hinge pin 80 to rotate the hinge pin 80 about the axis 92. As shown in FIGS. 5 and 6, when the hinge pin 80 is rotated as indicated by arrow 280, the circular flange 84 is advanced away from the upper surface 50 of the mounting plate 46, thereby causing the door 22 and the cam plates 114, 134 to also move upward. As the cam plate 134 moves upward, the plug 184 slides along the inner wall 64 of the mounting plate 46.

The assembly may continue to move upward until the upper surfaces 254, 266 of the catches 252, 264 are advanced into contact with the lower surface 52 of the mounting plate 46, as shown in FIG. 6. As described above, a vertical distance 276, which corresponds to the position of the door 22 relative to the cabinet 12 and the door 32, is defined between the circular flange 84 of the hinge pin 80 and the upper surface 50 of the mounting plate 46. As shown in FIG. 6, the vertical distance 276 has a maximum value when the upper surfaces 254, 266 of the catches 252, 264 are advanced into contact with the lower surface 52 of the mounting plate 46. In the illustrative embodiment, the maximum value of the distance 276 is approximately six millimeters.

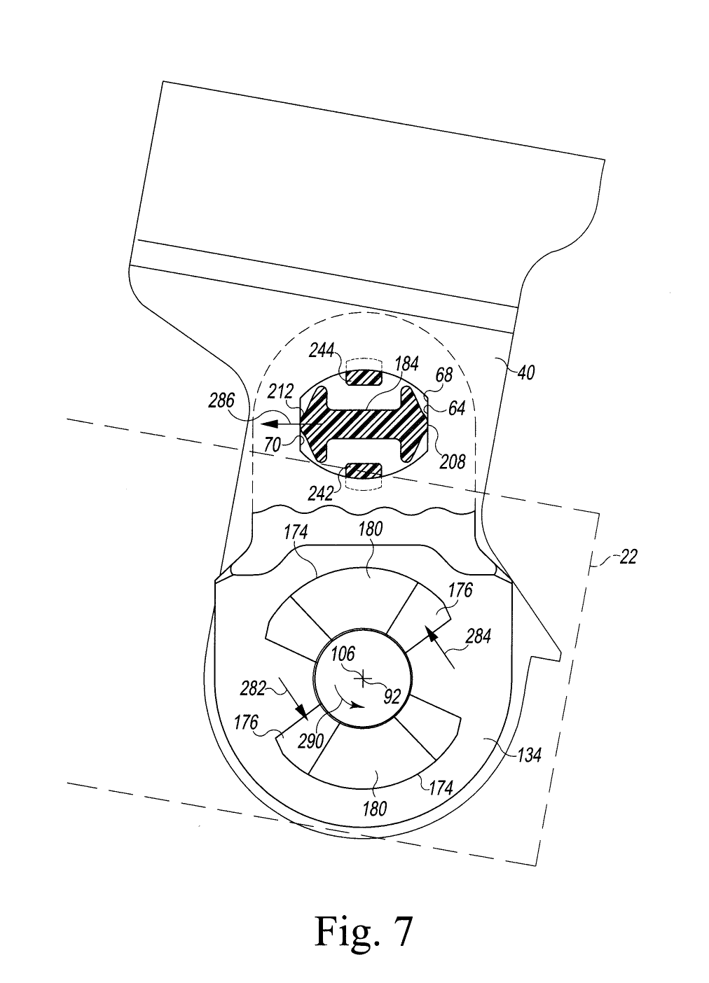

As described above, the door 22 is pivoted about an axis 106 as the door 22 is moved between the open and the closed position. When the door 22 is in the closed position, the cam surfaces 124, 126 of the walls 122 of the upper cam plate 114 confront the corresponding cam surfaces 176, 178 of the walls 174 of the lower cam plate 134, as shown in FIG. 1. When the user opens the door 22, the door 22 pivots about the axis 106 as indicated by arrow 290 in FIG. 7. As the door 22 pivots, the walls 122 of the upper cam plate 114 apply a load to the cam surfaces 176 of the lower cam plate 134 in the direction indicated by arrows 282, 284 in FIG. 7. The load is transferred through the lower cam plate 134 to the hinge bracket 40 via the rib 212 of the plug 184, as indicated by arrow 286 in FIG. 7.

The engagement between the rib 208 and the wall section 68 of the inner wall 64 of the hinge bracket 40 prevents the lower cam plate 134 from pivoting with the door 22 and the upper cam plate 114. As a result, the walls 122 of the upper cam plate 114 slide upwardly along the cam surfaces 176, 178 of the lower cam plate 134 as the door 22 is pivoted about the axis 106, thereby lifting the door 22 as the door 22 is opened.

When the user closes the door 22, the walls 122 of the upper cam plate 114 advance along the top surface 180 of the lower cam plate 134 and then downward along the cam surfaces 176, 178 of the lower cam plate 134 such that the door 22 is lowered as the door 22 is moved to the closed position.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A domestic refrigerator comprising:
a cabinet having a temperature-controlled compartment defined therein,
a door positioned at a front of the cabinet,
a first cam plate positioned at a first end of the door, the first cam plate including a first cam surface,
a hinge bracket coupled to the cabinet, the hinge bracket including a mounting plate and an inner wall that defines a slot through the mounting plate, and
a second cam plate positioned between the mounting plate and the first cam plate, the second cam plate comprising: (i) a plate body having a second cam surface engaged with the first cam surface of the first cam plate, and (ii) a plug extending from the plate body through the slot defined in the mounting plate, the plug including a resilient tongue having a catch formed thereon to engage a surface of the mounting plate to assist in retaining the second cam plate to the hinge bracket.

2. The domestic refrigerator of claim 1, further comprising a hinge pin coupled to the hinge bracket and extending through a bore defined in the plate body.

3. The domestic refrigerator of claim 2, wherein:
the hinge pin is threadingly coupled to the hinge bracket, and
when the hinge pin is rotated in a first direction, the door, the first cam plate, and the second cam plate are moved upward relative to the cabinet, and, when the hinge pin is rotated in a second direction, the door, the first cam plate, and the second cam plate are moved downward relative to the cabinet.

4. The domestic refrigerator of claim 3, wherein when the hinge pin is rotated in the first direction, the plug is configured to slide upward along the inner wall of the hinge bracket.

5. The domestic refrigerator of claim 2, wherein the plug defines a first longitudinal axis and the hinge pin defines a second longitudinal axis offset from and extending parallel to the first longitudinal axis.

6. The domestic refrigerator of claim 1, wherein the plug includes:
an outer surface facing the inner wall of the hinge bracket, and
a rib extending from the outer surface, the rib engaging the inner wall of the hinge bracket.

7. The domestic refrigerator of claim 6, wherein the outer surface of the plug is convex.

8. The domestic refrigerator of claim 6, wherein the slot defined in the mounting plate is oblong and assists in the alignment of the plug to the mounting plate.

9. The domestic refrigerator of claim 8, wherein the rib of the plug engages a substantially planar inner wall section of the inner wall, and the resilient tongue has an outer surface facing a concave inner wall section of the inner wall.

10. The domestic refrigerator of claim 1, wherein:
the resilient tongue is a first resilient tongue,
the plug includes a second resilient tongue extending parallel to the first resilient tongue, and
the plug includes a body positioned between the first resilient tongue and the second resilient tongue.

11. A refrigerator door hinge assembly, comprising:
a hinge bracket including a mounting plate and an inner wall that defines a slot through the mounting plate,
a cam plate coupled to the hinge bracket, the cam plate comprising: (i) a plate body having a cam surface configured to engage a corresponding cam surface positioned at a lower end of a refrigerator door, and (ii) a plug extending from the plate body through the slot defined in the mounting plate, and
a hinge pin moveably coupled to the hinge bracket, the hinge pin including a shaft that extends through an opening defined in the plate body,
wherein the plug of the cam plate includes (i) a pair of resilient tongues, each resilient tongue having a catch formed thereon to engage a bottom surface of the mounting plate, and (ii) a body positioned between the resilient tongues, the body engaging the inner wall of the hinge bracket.

12. The refrigerator door hinge assembly of claim 11, wherein the inner wall of the hinge bracket includes a pair of substantially planar wall sections and a pair of concave wall sections connecting the pair of substantially planar wall sections.

13. The refrigerator door hinge assembly of claim 12, wherein:
the body of the plug includes (i) a first beam including a first convex outer surface facing a first wall section of the pair of substantially planar wall sections, (ii) a second beam including a second convex outer surface facing a second wall section of the pair of substantially planar wall sections, and (iii) a third beam connecting the first beam to the second beam, and
each of the resilient tongues has an outer surface that faces one of the pair of concave wall sections.

14. The refrigerator door hinge assembly of claim 13, wherein the plug includes:
a first rib extending from the first convex outer surface, the first rib being engaged with the first wall section of the hinge bracket, and
a second rib extending from the second convex outer surface, the second rib being engaged with the second wall section of the hinge bracket.

15. A door cam plate for a domestic refrigerator, comprising:
a plate body including (i) an upper surface, (ii) a lower surface positioned opposite the upper surface, and (iii) a circular bore extending through the upper surface and the lower surface,
a pair of curved walls extending upwardly from the upper surface adjacent the circular bore, each curved wall including a cam surface configured to engage a corresponding cam surface positioned at a lower end of a refrigerator door, and
a plug extending downwardly from the lower surface of the plate body, the plug including:
(i) a first resilient tongue having a first catch extending outwardly from a lower end thereof,
(ii) a second resilient tongue having a second catch extending outwardly from a lower end thereof, and
(iii) a body positioned between the first resilient tongue and the second resilient tongue.

16. The door cam plate of claim 15, wherein the body includes:
a first beam including a first convex outer surface,
a second beam including a second convex outer surface, and
a third beam connecting the first beam to the second beam.

17. The door cam plate of claim 16, wherein the plug includes a first rib extending outwardly from the first convex outer surface and a second rib extending outwardly from the second convex outer surface.

18. The door cam plate of claim 17, wherein the third beam defines an axis, and the first rib and the second rib are positioned on the axis.

19. The door cam plate of claim 18, wherein:
the first catch extends in a first direction orthogonal to the axis, and
the second catch extends in a second direction opposite the first direction and orthogonal to the axis.

20. The door cam plate of claim 15, wherein the plate body includes a convex outer surface connecting the upper surface and the lower surface.
